(19) United States
(12) Patent Application Publication
(10) Pub. No.: US 2022/0161868 A1
(43) Pub. Date: May 26, 2022

(54) Vehicle Roof Comprising a Painted Rigid Roof Module

(71) Applicant: Webasto SE, Stockdorf (DE)

(72) Inventors: Dirk Legler, Stockdorf (DE); Michael Deppe, Stockdorf (DE); Theodor Striegl, Stockdorf (DE)

(21) Appl. No.: 17/519,746

(22) Filed: Nov. 5, 2021

(30) Foreign Application Priority Data
Nov. 25, 2020 (DE) 10 2020 131 219.9

(51) Int. Cl. B62D 29/04; B62D 25/06; B32B 3/12; C09D 133/08

(52) U.S. Cl. CPC B62D 29/043; B62D 25/06; B32B 3/12; C09D 133/08; C09D 5/002; B32B 2255/26; B32B 2250/02; B32B 2260/021; B32B 2605/08

(57) ABSTRACT

A vehicle roof comprising a base structure and a rigid roof panel which is attached to the base structure and which is a composite component having at least one structural layer, which is a fiber matrix layer, and a design paint, which forms a visible surface on an outer side of the structural layer, the composite component having a machining edge provided with a sealing paint covered by the design paint.

The invention relates to a vehicle roof comprising a base structure and a rigid roof panel which is attached to the base structure and which is a composite component comprising a structural layer having a design paint, which forms a visible surface, on its outer side.

A vehicle roof of this kind is known from practice and is in particular a variable vehicle roof comprising a rigid roof panel connected to a base structure in a detachable manner so as to form a roof opening, the base structure comprising transverse roof beams and/or longitudinal roof beams, for example. The roof panel is a composite component, which can have a backing layer comprising in particular a honeycomb structure provided with a glass fiber/polyurethane mixture on both sides. A structural layer, which is a fiber matrix layer and consequently forms what is known as an SMC (sheet molding compound) layer, is disposed on a side of the backing layer facing the vehicle environment. An outer side of the structural layer, which faces the vehicle environment, can be provided with a design paint forming a visible surface of the roof panel.

The roof panel of the kind described above presents the problem that machining resulting in a machining edge has not been possible so far since the roof panel cannot be provided with a final coat in the area of the machining edge since said final coat would blister, which would disturb the appearance of the roof panel.

The object of the invention is to provide a vehicle roof of the kind described above which can be machined before it is fully covered in a final coat without the final coat causing bubbles to form on the finished product in the area of a machining edge.

According to the invention, this object is attained by the vehicle roof having the features of claim 1.

So according to the invention, a vehicle roof is proposed which comprises a base structure and a rigid roof panel which is attached to the base structure and which is a composite comprising at least one structural layer, which is a fiber matrix layer, and a design paint, which forms a visible surface on an outer side of the structural layer, the composite component having a machining edge provided with a sealing paint covered by the design paint.

So the rigid roof panel of the vehicle roof according to the invention has an edge that has been produced by machining the composite component after its molding by milling or cutting, for example, and a sealing layer, which forms a closed surface preventing solvents or the like contained in the design paint from entering an open surface of the composite component. In this way, outgassing and blistering in the area of the machining edge as a result of the painting with the design paint can be prevented.

The composite component of the vehicle roof according to the invention has, as a structural layer, a layer that is a fiber matrix layer. A layer of this kind is what is known as an SMC (sheet molding compound) layer, which comprises a matrix made of an in particular thermosetting reaction resin in which reinforcing fibers (glass fibers and/or carbon fibers) are embedded in the form of chopped fibers or in the form of a mat or a fabric. In particular, it is also conceivable for the fiber matrix layer to be produced from a fiber-matrix semi-finished product. Production takes place in a mold.

The base structure of the vehicle roof can comprise at least one longitudinal roof beam and/or at least one transverse roof beam which is connected to a vehicle shell or a vehicle body in a permanent manner or a detachable manner. The roof panel can be permanently disposed on the base structure or be detachable therefrom or movable relative thereto. It is also conceivable for the base structure to be a top linkage of a convertible top, in which case the roof panel can be a rigid roof shell of the top.

In a preferred material-saving embodiment of the vehicle roof according to the invention, the outer side of the structural layer has a central portion which is free from the sealing paint and which is provided with the design paint. So the sealing paint is applied only locally in the area of the machining edge in order to prevent outgassing and blistering in this critical area.

In order to ensure a reliable effect of the sealing paint, the sealing paint forms an edge strip on the outer side of the structural layer, i.e., the sealing paint extends beyond the machining edge. The central portion is adjacent to said edge strip, which has in particular a width of few millimeters or centimeters.

In order to ensure that the design paint is durably disposed on the composite component, a primer may be provided, which covers the sealing paint and which is in turn covered by the design paint.

In an embodiment of the vehicle roof according to the invention which is advantageous for reasons of stiffness, the structural layer is disposed on a backing layer which is part of the composite component. The backing layer can in particular comprise a honeycomb structure, such as a paper honeycomb structure, which can in turn be provided with a polyurethane/glass fiber mixture on one side or on both sides.

In a preferred embodiment, the sealing paint with which the machining edge of the roof panel of the vehicle roof according to the invention is provided is a paint cross-linking under UV radiation. This paint preferably does not soften at the typical drying temperatures used for drying the design paint, which are typically in the range of about 90° C. Additionally, it does not form cracks through which a solvent could enter the structural layer via the machining edge. Furthermore, the paint cross-linking under UV radiation is preferably a single-component system which does not have to be mixed prior to being applied to the cutting edge and which has a very long open time.

Preferably, the sealing paint is solvent-free. The sealing paint can be dried in few seconds by means of a UV lamp, for example, after application.

The process for applying the sealing paint does not require a special painting installation, which allows the process to be performed very variably.

In an advantageous embodiment, the sealing paint with which the cutting edge of the roof panel of the vehicle according to the invention is provided is an acrylate paint, i.e., a paint produced on the basis of at least one acrylate compound.

For example, the scaling paint sealing the machining edge of the composite component comprises at least one compound from the group consisting of
dipropylene glycol diacrylate
trihydroxymethylpropyl triacrylate
trimethylolpropane triacrylate
neopentyl glycol diacrylate ester (propolyated)
2-hydroxy-2-methylpropiophenone
methyl benzoylformates
1,6-hexanediol diacrylate
ethyl phenyl(2,4,6-trimethylbenzoyl)phosphinate.

The invention also relates to the use of a sealing paint for sealing a machining edge of a composite component which is a rigid roof panel of a vehicle roof or a panel of a convertible vehicle structure, such as a rigid roof shell of an RHT (retractable hard top) or a top compartment lid, and which comprises a structural layer which is a fiber matrix layer.

Other advantages and advantageous configurations of the subject matter of the invention are apparent from the description, the drawing and the claims.

An example of an embodiment of a vehicle roof according to the invention is schematically illustrated in the drawing and will be discussed in more detail in the following description.

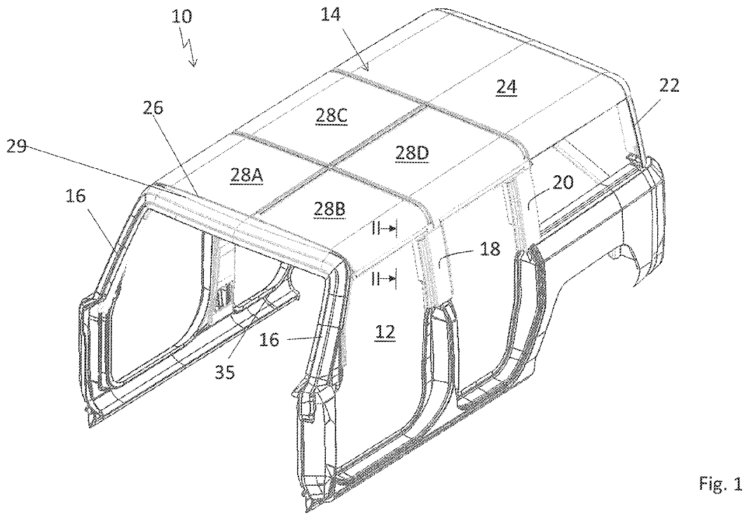

FIG. 1 shows a vehicle body having a vehicle roof according to the invention; and

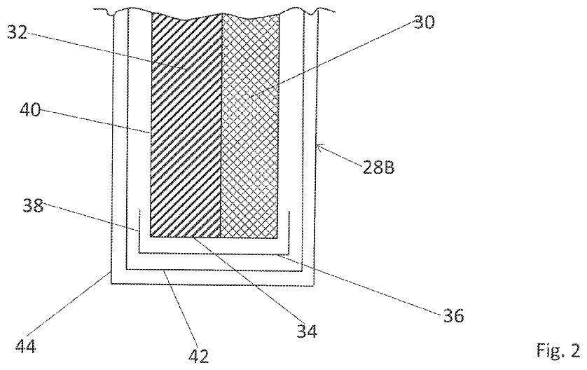

FIG. 2 is a highly schematized section through a roof panel of the vehicle roof of FIG. 1 along line II-II in FIG. 1.

FIG. 1 shows a vehicle structure 10 of an off-road vehicle having a vehicle interior 12 covered by a vehicle roof 14. Vehicle structure 10 has four pillars 16, 18, 20 and 22 on either side of a vertical longitudinal center plane of the vehicle, pillar 16 forming what is known as an A-pillar, pillar 18 forming what is known as a B-pillar, pillar 20 forming what is known as a C-pillar, and pillar 22 forming what is known as a D-pillar. In the area between pillars 20 and pillars 22, vehicle roof 14 has a solid roof portion 24 mounted rigidly or permanently relative to vehicle structure 10. In the area between pillars 16 and pillars 20, vehicle roof 14 has a roof opening 26 which can be closed with four rigid and removable roof panels 28A, 28B, 28C and 28D.

Roof panels 28A, 28B, 28C and 28D, which are attached to a base structure 29 of vehicle roof 14, which comprises transverse roof beams and longitudinal roof beams, when in the installed position, each are a lightweight composite component comprising a backing layer 30 as illustrated in the case of roof panel 28B in FIG. 2, backing to layer 30 being formed by a honeycomb structure provided with a polyurethane/glass giber mixture on both sides. A structural layer 32, which is a fiber matrix layer or an SMC (sheet molding compound) layer and faces the vehicle environment, is disposed on backing layer 30. The composite component formed by backing layer 30 and structural layer 32 has a machining edge 34 which is produced by milling and which in particular exposes the structure of structural layer 32.

In a cross section, machining edge 34 is covered by a sealing paint 36 in a U-shape, sealing paint 36 forming an edge strip 38 on the outer side of structural layer 32, edge strip 38 being adjacent to a central portion 40 of the composite component, central portion 40 being located on the outer side of the rigid roof panel and being free from the sealing paint.

Furthermore, the composite component is provided with a primer 42 on machining edge 34 and on its outer side, primer 42 covering machining edge 34 and consequently also sealing paint 36. Primer 42 is in turn a substrate for a design paint 44 applied to the entire surface, design paint 44 also covering sealing paint 36 and central portion 40 adjacent to sealing paint 36 and forming the visible surface of respective roof panels 28A, 28B, 28C and 28D.

Sealing paint 36 covering machining edge 34 is an acrylate paint cross-linking under UV radiation. In particular, the sealing paint consists of a mixture of substances that comprises the following compounds:
dipropylene glycol diacrylate
trihydroxymethylpropyl triacrylate
trimethylolpropane triacrylate
neopentyl glycol diacrylate ester (propolyated)
2-hydroxy-2-methylpropiophenone
methyl benzoylformates
1,6-hexanediol diacrylate
ethyl phenyl(2,4,6-trimethylbenzoyl)phosphinate.

### REFERENCE SIGNS

10 vehicle structure
12 vehicle interior
14 vehicle roof
16 pillar
18 pillar
20 pillar
22 pillar
24 solid roof portion
26 roof opening
28A, B, C, D roof panel
29 base structure
30 backing layer
32 structural layer
34 machining edge
36 sealing paint
38 edge strip
40 central portion
42 primer
44 design paint

1. A vehicle roof comprising:
a base structure and a rigid roof panel which is attached to the base structure and which is a composite component comprising at least one structural layer, which is a fiber matrix layer, and a design paint, which forms a visible surface on an outer side of the structural layer, the composite component having a machining edge provided with a sealing paint covered by the design paint.

2. The vehicle roof according to claim 1, wherein the outer side of the structural layer has a central portion which is free from the sealing paint and which is provided with the design paint.

3. The vehicle roof according to claim 1, wherein the outer side of the structural layer is provided with the sealing paint in an edge strip.

4. The vehicle roof according to claim 1, wherein the design paint is disposed on a primer covering the sealing paint.

5. The vehicle roof according to claim 1, wherein the structural layer is disposed on a backing layer.

6. The vehicle roof according to claim 5, wherein the backing layer comprises a honeycomb structure.

7. The vehicle roof according to claim 1, wherein the sealing paint is a paint cross-linking under UV radiation.

8. The vehicle roof according to claim 1, wherein the sealing paint is free from solvents.

9. The vehicle roof according to claim 1, wherein the sealing paint is an acrylate paint.

10. The vehicle roof according to claim 1, wherein the sealing paint comprises at least one compound selected from the group consisting of
dipropylene glycol diacrylate;
trihydroxymethylpropyl triacrylate;
trimethylolpropane triacrylate;
neopentyl glycol diacrylate ester (propolyated);
2-hydroxy-2-methylpropiophenone;
methyl benzoylformates;
1,6-hexanediol diacrylate; and
ethyl phenyl(2,4,6-trimethylbenzoyl)phosphinate.

11. A use of a sealing paint for sealing a machining edge of a composite component, the composite component being a rigid roof panel of a vehicle roof or a panel of a convertible vehicle structure and comprising a structural layer which is a fiber matrix layer.

12. The use according to claim 11, wherein the sealing paint is an acrylate paint.

13. The use according to claim 11, wherein the sealing paint is a paint cross-linking under UV radiation.

14. The use according to claim 11, wherein the sealing paint comprises at least one compound selected from the group consisting of
dipropylene glycol diacrylate;
trihydroxymethylpropyl triacrylate;
trimethylolpropane triacrylate;
neopentyl glycol diacrylate ester (propolyated); and
2-hydroxy-2-methylpropiophenone.
